(19) United States
(12) Patent Application Publication
(10) Pub. No.: US 2022/0244833 A1
(43) Pub. Date: Aug. 4, 2022

(54) INTERACTIVE 3D ROOF MODEL

(71) Applicant: Primitive LLC, Edina, MN (US)

(72) Inventors: Randy Milbert, Edina, MN (US); Vishal Laddha, Livingston, NJ (US)

(21) Appl. No.: 17/647,366

(22) Filed: Jan. 7, 2022

Related U.S. Application Data
(60) Provisional application No. 63/199,757, filed on Jan. 22, 2021.

(51) Int. Cl. G06F 3/04815; G06F 3/04845; G06T 17/20; G06T 19/20

(52) U.S. Cl. CPC G06F 3/04815; G06F 3/04845; G06T 17/20; G06T 2219/2012; G06T 2200/24; G06T 2219/2004; G06T 19/20

(57) ABSTRACT

A computer readable medium having executable code that causes one or more processors to: obtain a digital roof model corresponding to a roof of a structure; determine facet edge elements for a 3D model of the structure based on the roof model, the facet edge elements representing roof facet edges of the roof; determine roof facet meshes for the 3D model based on the roof model, the roof facet meshes representing roof facets of the roof; and provide an interface enabling a user to view at least a portion of the 3D model, the at least a portion including the facet edge elements and/or the roof facet meshes, the interface enabling the user to manipulate the at least a portion of the 3D model to alter a view and/or alter characteristics of the at least a portion of the 3D model.

### CROSS-REFERENCE TO RELATED APPLICATION(S)

This application claims priority to U.S. Provisional Pat. Appl. No. 63/199,757, titled “INTERACTIVE ROOF REPORT,” filed Jan. 22, 2021, which is hereby incorporated by reference herein in its entirety.

### FIELD OF THE INVENTION

The present disclosure relates to estimating and visualizing construction projects. Particularly, the present disclosure relates to displaying roof measurements, estimating project materials, and visualizing various designs.

### BACKGROUND OF THE INVENTION

The background description provided herein is for generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

When a homeowner decides to replace a roof, he or she will often contact multiple roofing contractors for estimates. To develop an estimate, a roofing contractor needs roof measurements. To obtain these, most roofing contractors order a roof report. These roof reports provide roof measurements derived from imagery. With this information, the roofing contractor will develop an estimate. The type of roofing material selected will have a significant impact on this estimate, so the roofing contractor will often present the homeowner with multiple options.

There are several companies that provide roof reports. For example, see U.S. Pat. Nos. 8,078,436; 8,145,578; 8,170,840; 8,209,152; 8,401,222; 8,731,234; 9,183,538; 10,803,658; and 10,861,247. In general, these companies deliver a roof report as a static PDF document with overhead diagrams and measurement tables. These reports are helpful, but they have limitations. With an overhead view, it is difficult to depict overlapping roof facets and edges. Also, with such a static document, it is hard to display measurements for every facet and edge in a complex roof. For example, elements of the roof or measurements/labels may become difficult for a viewer to see and/or the static document can become quite cluttered and substantially unviewable or unreadable. Also, it is difficult for a roofing contractor to visualize a complex roof from an overhead view alone. Additionally, there is no way for the roofing contractor to visualize different designs or present these to the homeowner.

What is needed is a better way to present roof measurements that enables a roofing contractor to view the roof from any angle, zoom in to view details, visualize overlapping roof sections, experiment with various designs, and present this information in a compelling way to the homeowner.

### BRIEF SUMMARY OF THE INVENTION

The following presents a simplified summary of one or more embodiments of the present disclosure to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, is a computer-implemented method for presenting interactive roof reports. In one embodiment, a user begins by opening a web page. The application may display an interactive 3D roof model with measurements. The application may enable the user to view lengths, pitches, or areas of different elements or portions of a roof corresponding to the roof model. The user may rotate, pan, or zoom the model. The application may overlay measurements directly on the model. The application may also present overall measurements including roof area, facet count, predominant pitch, and edge lengths, as well as identify edge types (e.g., bend, continuous flashing, drip edge, eave, hip, leak barrier, parapet, rake, ridge cap, ridge, starter, step flashing, and valley). The application may also present material estimates for materials such as shingle bundles, starter materials, roof deck protection, leak barriers, and ridge caps. The application may also support a design mode where the user may select roofing and wall materials for a structure (e.g., a house or building and its roof). The application may present an interactive 3D view of the structure with the selected materials. The application may also provide controls or buttons for viewing images of the house including, but not limited to, an overhead view as well as north, east, south, and west views. The application may also enable the user to tap a button to continuously spin the model.

The present disclosure has several advantages over existing roof reports. Due to its interactive nature, the present disclosure enables a user to zoom in on roofing details and easily see measurements for all roof facets and edges. Also, the present disclosure overlays these measurements directly on the 3D model versus listing them in a table so a user can instantly see which measurements correspond to which edge or facet. Also, unlike a static overhead view, an interactive 3D view enables a user to visualize a roof from multiple angles and therefore make better decisions about, for example, how best to shingle a roof, how to protect it from weather damage, how to access the roof, and how to manage removing the old roof and discarding those materials. In addition, the present disclosure enables a user to experiment with various designs by selecting roofing and wall materials and seeing them overlaid on a home or building structure in 3D. The user can also use this interactive roof model and design view as a sales tool when interacting with a homeowner. An interactive 3D model is more impressive than a static PDF and illustrates the roofing contractor's technical proficiency and expertise. The design view also helps the homeowner understand various design choices including type of shingles and wall materials. The result is that a roofing contractor can develop a more accurate estimate, the homeowner can select the best materials, and the roofing contractor can secure more business.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a diagram of a system for estimating and visualizing construction projects, according to an embodiment of the present disclosure.

FIG. 2 is a general overview flowchart for a method of estimating and visualizing construction projects, according to an embodiment of the present disclosure.

FIG. 3 is a flowchart for constructing facet edge elements representing facet edges in an embodiment of the present disclosure.

FIG. 4 is a flowchart for constructing roof meshes in an embodiment of the present disclosure.

FIG. 5 is a flowchart for constructing wall meshes in an embodiment of the present disclosure.

FIG. 6 is a flowchart for constructing an orbit controller in an embodiment of the present disclosure.

FIG. 7 is a flowchart displaying image thumbnails in an embodiment of the present disclosure.

FIG. 8 is a flowchart for computing measurements in an embodiment of the present disclosure.

FIG. 9 is a flowchart for estimating materials in an embodiment of the present disclosure.

FIG. 10 is a flowchart for responding to mode button clicks in an embodiment of the present disclosure.

FIG. 11 is a flowchart for responding to spin button clicks in an embodiment of the present disclosure.

FIG. 12 is a flowchart for responding to waste factor selection in an embodiment of the present disclosure.

FIG. 13 is a flowchart for responding to roof texture selection in an embodiment of the present disclosure.

FIG. 14 is a flowchart for responding to wall texture selection in an embodiment of the present disclosure.

FIG. 15 is a flowchart for responding to image thumbnail clicks in an embodiment of the present disclosure.

FIG. 16 is a table listing facet edge colors in an embodiment of the present disclosure.

FIG. 17 is an example display showing an overhead view of facet edge lengths in an embodiment of the present disclosure.

FIG. 18 is an example display showing a tilted view of facet edge lengths in an embodiment of the present disclosure.

FIG. 19 is an example display showing an overhead view of facet pitches in an embodiment of the present disclosure.

FIG. 20 is an example display showing a tilted view of facet pitches in an embodiment of the present disclosure.

FIG. 21 is an example display showing an overhead view of facet areas in an embodiment of the present disclosure.

FIG. 22 is an example display showing a tilted view of facet areas in an embodiment of the present disclosure.

FIG. 23 is an example display showing an overhead view of a structure design in an embodiment of the present disclosure.

FIG. 24 is an example display showing a tilted view of a structure design in an embodiment of the present disclosure.

FIG. 25 is an example display showing a structure design after the user has selected roof and wall textures in an embodiment of the present disclosure.

FIG. 26 is an example display showing material estimates for a given waste level in an embodiment of the present disclosure.

FIG. 27 is an example display showing an enlarged image after the user has clicked a thumbnail in an embodiment of the present disclosure.

FIG. 28 is a block diagram schematic of various example components of an example machine that can be used as, for example, a client and/or server of the present disclosure.

### DETAILED DESCRIPTION

The present disclosure relates to novel and advantageous systems and methods for estimating and visualizing construction projects. In particular, the present disclosure relates to novel and advantageous system and methods for displaying roof measurements, estimating project materials, and visualizing various designs.

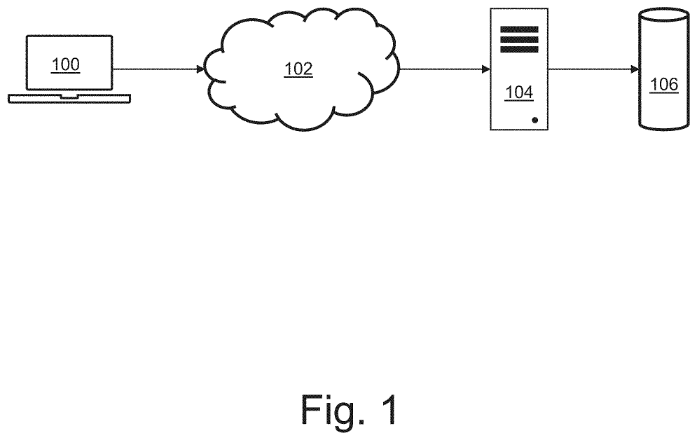

FIG. 1 is a system diagram illustrating an embodiment of the present disclosure. In it, a client 100 may connect via a network 102 to a server 104 which has access to a database 106. The client 100 may be a computer, tablet, phone, etc. The network 102 may be a local area network, wide area network, etc. The server 104 may be on-premises, on cloud computing architecture (“the cloud”), etc. The database 106 may be any kind of database or database architecture (e.g., but not limited to, Amazon SimpleDB, Google Cloud Datastore, MongoDB, Oracle, PostgreSQL, etc.). The client 100 may run an application that is desktop-based, web-based, etc. The database 106 may contain imagery, roof models, and any other data described herein as created, received, or used by part of the systems or during the methods described herein, etc. The imagery may include overhead, oblique, and ground-based imagery. The imagery may have been captured by airplanes, drones, satellites, etc. Not to be limited by the foregoing, any one or more of the hardware and software components of the present disclosure may be integral portions of a single computer, server, or controller, or may be connected parts of a computer network. The hardware and software components may be located within a single location or, in other embodiments, portions of the hardware and software components may be divided among a plurality of locations and connected directly or through a local, wide area, or global computer information network, such as the network 102, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

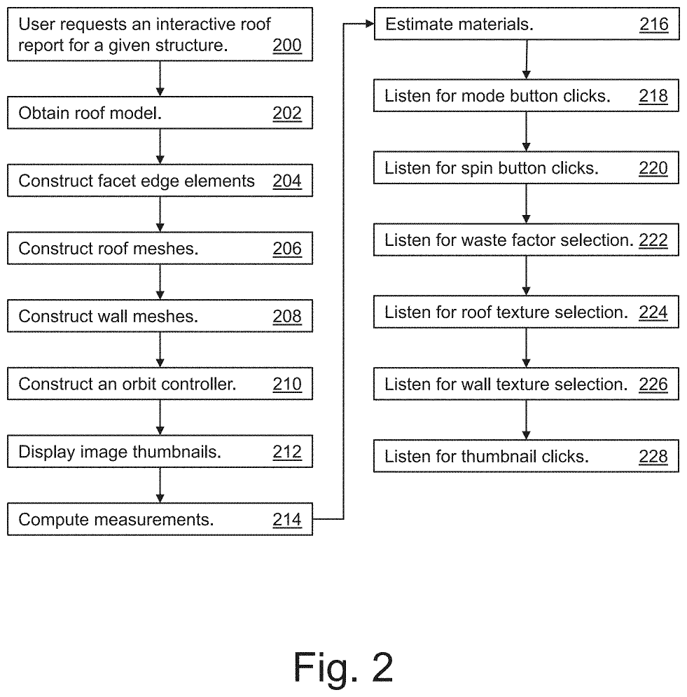

FIG. 2 is a nonlimiting overview flowchart for a method of an embodiment of the present disclosure. In general, a user may begin at step 200 by requesting an interactive roof report for a given structure (e.g. a single-family home, multifamily home, or commercial building) using, for example, an application running at or accessed through the client 100. The application may alternatively or additionally run at or be accessed through the server 104, or parts of the application may run at or be accessed through the client 100 while other parts of the application may run at or be accessed through the server 104. At step 202, the application may obtain a roof model from the database 106. At step 204, the application may construct facet edge elements representing roof facet edges. Such facet edge elements may be in the form of a line, rectangle, cylinder, mesh, any other suitable 2D or 3D shape, or any combination of such shapes. At step 206, the application may construct roof facet meshes. At step 208, the application may construct wall meshes. At step 210, the application may construct an orbit controller. At step 212, the application may display image thumbnails. At step 214, the application may compute roof measurements. At step 216, the application may estimate roof materials. At step 218, the application may construct an event listener to respond to mode button clicks. At step 220, the application may construct an event listener to respond to spin button clicks. At step 222, the application may construct an event listener to respond to waste factor selection. At step 224, the application may construct an event listener to respond to roof texture selection. At step 226, the application may construct an event listener to respond to wall texture selection. At step 228, the application may construct an event listener to respond to thumbnail clicks.

In an embodiment of the present of the present disclosure, the application may be implemented in a web page using HTML, CSS, JavaScript, and/or any other suitable programming language. To render 3D models, the application may use Three.js (https://threejs.org) or any other suitable 3D rendering library or algorithm.

Roof models in the database 106 may be generated by any suitable method. An example method of generating roof models from imagery is described in U.S. Pat. No. 10,861,247, which is hereby incorporated by reference herein in its entirety. The following is an example roof model. This roof model is expressed in the JSON format, but it could be expressed in any other suitable format, such as XIL, CSV, YAML, etc., or any combination of formats. This example is for a simple roof with two rectangular roof facets. The roof model contains a facet list. Each facet contains an area (in square meters), a constant and normal defining the facet's plane, and a vertex list specifying the facet's boundary. Each facet also has an edge type list. The edge types may include bend, continuous flashing, eave, hip, parapet, rake, ridge, step flashing, valley, etc. Each edge type in the list may correspond to a respective edge between two vertices in the vertex list. For example, looking at the first facet in this sample, the edge between vertices 1 and 2 represents a rake, the edge between vertices 2 and 3 represents an eave, the edge between vertices 3 and 4 represents a rake, and the edge between vertices 4 and 1 represents a ridge.

```
{
  ″facets″:[
    {
      ″area″:64.82643464427314,
      constant″:101.31545990554255,
      ″edgeTypes″:[
        ″Rake″,
        ″Eave″,
        ″Rake″,
        ″Ridge″
      ],
      ″normal″:{
        ″x″0,05362232073670834,
        ″y″:0.9457518024736181,
        ″z″:0.3204343533966232
      },
      ″vertices″:
        {
          ″x″:−6.721857444010082,
          ″y″:107.46466632477622,
          ″z″:2.1217561785832886
        },
        {
          ″x″:−7.45714524469129,
          ″y″:105.93425795909232,
          ″z″:−2.2721504583296612
        },
        {
          ″x″:6.116105190836929,
          ″y″:105.93425795909232,
          ″z″:−4.543533599926454
        },
        {
          ″x″:6.8513929915181055,
          ″y″:107.46466632477622,
          ″z″:−0.14962696301350759
        }
      ]
    },
    {
      area″:64.82643464427301,
      constant:−101.95434385222352,
      ″edgeTypes″:
        ″Rake″,
        ″Eave″,
        ″Rake″,
        ″Ridge″
      ],
      ″normal″:{
        ″x″:0.05362232073670855,
        ″y″:0.9457518024736181,
        ″z″:0.320434353396623
      },
      ″vertices″:[
        {
          ″x″:−6.721857444010082,
          ″y″:107.46466632477622,
          ″z″:2.1217561785832886
        },
        {
          ″x″:−5.986569643328879,
          ″y″:105.93425795909232,
          ″z″:6.515662815496241
        },
        {
          ″x″:7.586680792199282,
          ″y″:105.93425795909232,
          ″z″:4.244279673899438
        },
        {
          ″x″:6.8513929915181055,
          ″y″:107.46466632477622,
          ″z″:−0.14962696301350759
        }
      ]
    }
  ]
}
```

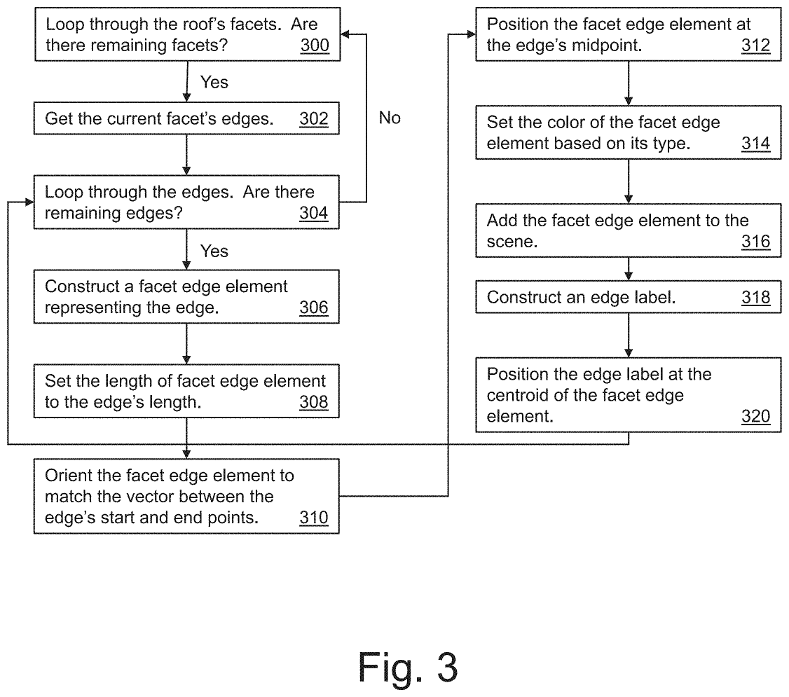

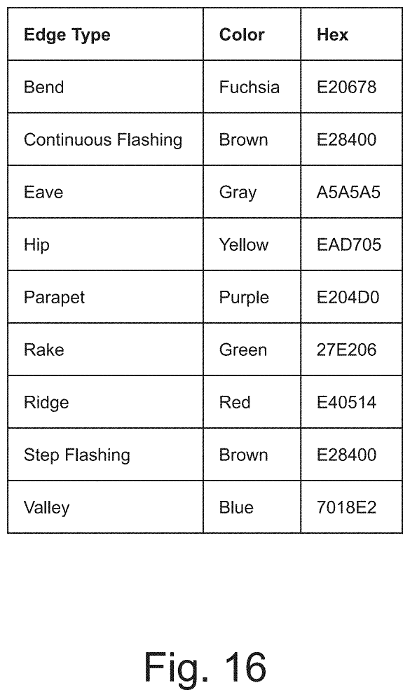

FIG. 3 is a flowchart for an example method of constructing facet edge elements representing facet edges (e.g., step 204 in FIG. 2) for an interactive 3D model. In it, the application may begin at step 300 by starting to loop through the roof's facets. If there are remaining facets, the application may advance to step 302. At step 302, the application may retrieve the edges corresponding to the current facet. The edges may be determined, for example, based on a vertex list in a roof model, such as that provided as an example above. At step 304, the application may begin to loop through the edges of the current facet. If the application has finished looping through the current facet's edges, the application may return to step 300 and advance to the next facet. If there are remaining edges, the application may advance to step 306. At step 306, the application may construct a facet edge element representing the current edge. As indicated previously, such a facet edge element may be in the form of a line, rectangle, cylinder, mesh, any other suitable 2D or 3D shape, or any combination of such shapes. In an example, the application may construct a cylinder (e.g., using THREE.CylinderGeometry) as the facet edge element representing the current edge. At step 308, the application may set the length of the facet edge element (e.g., the length of the line, rectangle, cylinder, etc. as may be the case) to the current edge's length. At step 310, the application may orient the facet edge element to match or align with the orientation of the vector between the current edge's start and end points, for example, based on the corresponding vertices in the vertex list. At step 312, the application may set the center point of the facet edge element at the current edge's midpoint. At step 314, the application may set the color of the facet edge element based on its edge type (see also FIG. 16 infra), which may be pre-assigned or predefined by or within the application or configured, including dynamically, by the user. At step 316, the application may add the facet edge element to the scene (e.g., using THREE.Scene) displayed to the user at client 100. At step 318, the application may construct an edge label for the current edge. The application may use the edge label to display the edge's length or other information. At step 320, the application may position the edge label at or near the centroid of the facet edge element or any other suitable location such that it can be readily recognized that the label is associated with the edge or facet edge element. Following this, the application may return to step 304 to continue looping through edges.

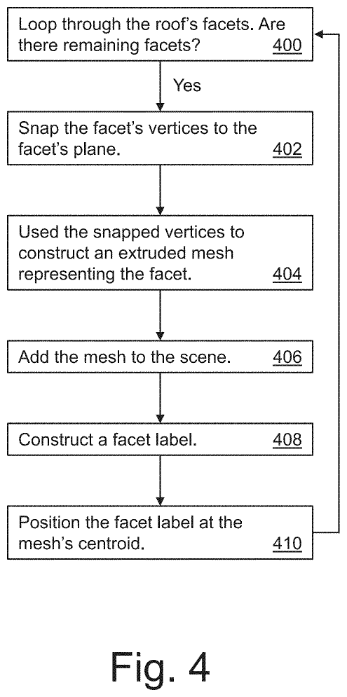

FIG. 4 is a flowchart for an example method of constructing roof facet meshes (e.g., step 206 in FIG. 2) for a 3D model. In it, the application may begin at step 400 by starting to loop through the roof's facets. If there are remaining facets, the application may advance to step 402. At step 402, the application may snap the facet's vertices to the facet's plane, which is defined, for example, by the facet's constant and normal (e.g., using THREE.Plane). The application may do this by finding the closest point on the facet's plane to each facet vertex. At step 404, the application may use the snapped vertices to construct an extruded mesh (e.g., using THREE.ExtrudeGeometry) representing the facet. At step 406, the application may add the roof facet mesh to the scene (e.g., using THREE.Scene) displayed to the user at client 100. At step 408, the application may construct a facet label. The application may use the facet label to display the facet's pitch, area, or other information. At step 410, the application may position the facet label at or near the mesh's centroid or any other suitable location such that it can be readily recognized that the label is associated with the facet or mesh. Following this, the application may return to step 400 to continue looping through facets, until there are no more facets.

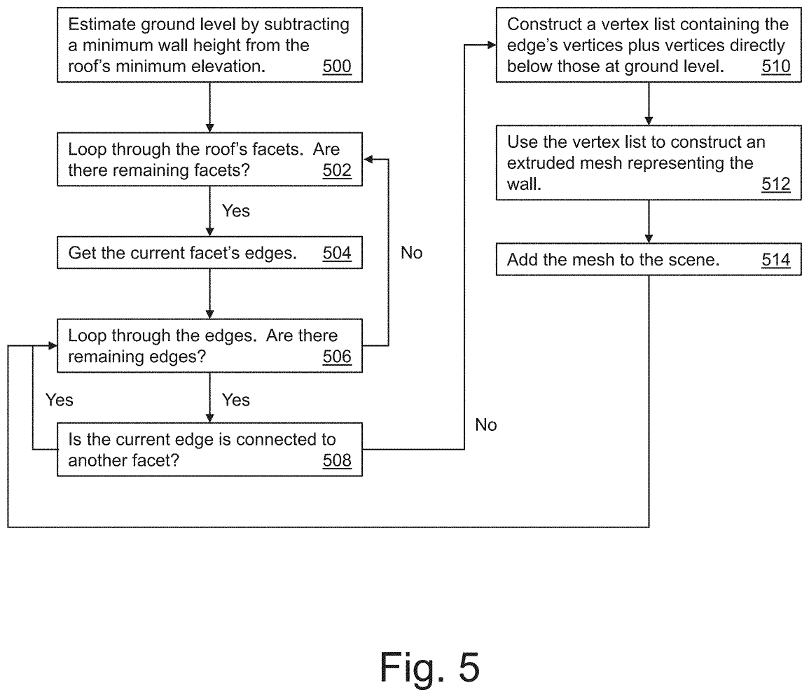

FIG. 5 is a flowchart for an example method of constructing wall meshes (e.g., step 208 in FIG. 2) for a 3D model. In it, the application may begin at step 500 by estimating the ground level by subtracting a minimum wall height (e.g., 3 meters) from the roofs minimum elevation. The minimum wall height may be pre-assigned or predefined by or within the application and/or may be any suitable value, as required or desired. The minimum wall height may additionally or alternatively be assigned or adjusted, including dynamically, for any given 3D model or scene. In the sample roof model above, the roof's minimum elevation (i.e., the minimum y value) is approximately 105.9 meters. Subtracting 3 meters, for example, from that, the application would get an estimated ground elevation of 102.9 meters. As indicated, other suitable minimum wall heights other than 3 meters may also be used. At step 502, the application may begin looping through the roofs facets. If there are remaining facets, the application may advance to step 504. At step 504, the application may get the current facet's edges. For example, as determined previously such as at step 302, or based on a vertex list in a roof model, such as that provided as an example above. At step 506, the application may begin looping through the edges. If the current facet has no remaining edges, the application may return to step 502. If current facet has remaining edges, the application may advance to step 508. At step 508, the application may determine whether the current edge is connected to another facet (e.g., by searching the other facets for an edge with endpoints equivalent to the current edge's endpoints). If the edge is connected (e.g., it represents a ridge or valley), the application may return to step 506. If the edge is disconnected (e.g., it represents an eave or rake), the application may advance to step 510. At step 510, the application may construct a vertex list containing the edge's vertices plus vertices directly below those at ground level (e.g., the estimated ground elevation determined at step 500). At step 512, the application may use the vertex list to construct an extruded mesh (e.g., using THREE.ExtrudeGeometry) representing a wall of the structure of the 3D model. At step 514, the application may add the wall mesh to the scene (e.g., using THREE. Scene) displayed to the user at client 100. Following this, the application may return to step 506 to continue looping through edges.

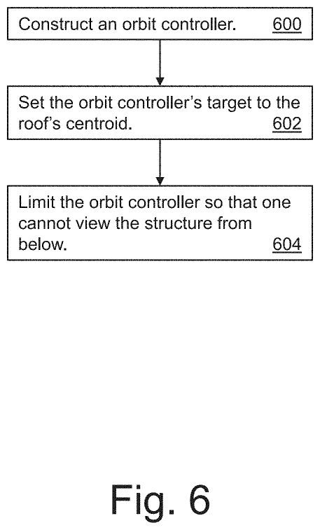

FIG. 6 is a flowchart for an example method of constructing an orbit controller (e.g., step 210 in FIG. 2). An orbit controller enables a user to rotate, pan, and zoom a 3D scene. In it, the application may begin at step 600 by constructing an orbit controller (e.g., using TI-EE OrbitControls). At step 602, the application may set the orbit controller's target to the roof's centroid or other suitable location, such as but not limited to, a point translated from the roofs centroid to the estimated ground level or a point translated from the roof's centroid to a location somewhere between the roof's centroid and the estimated ground level. The orbit controller will cause the viewing angle of the scene to orbit around this location. At step 604, the application may restrict the orbit controller so that the user cannot view the structure from below (e.g., beneath the estimated ground level). For example, the application may set the orbit controller's maximum polar angle to pi divided by two and set the orbit controller's minimum polar angle to negative pi divided by two.

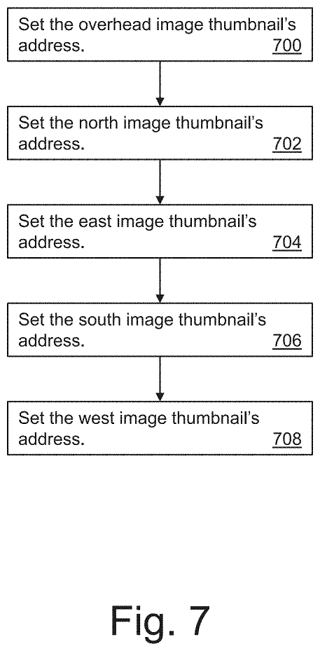

FIG. 7 is a flowchart for an example method of displaying one or more image thumbnails (e.g., step 212 in FIG. 2) of a structure. In it, the application may begin at step 700 by setting, if available, an overhead image thumbnail's source address (e.g., /image?lat=44.90423&lon=−93.34609&type=overhead). At step 702, the application may set, if available, a north image thumbnail's source address (e.g., /image?lat=44.90423&lon=−93.34609&type=north). At step 704, the application may set, if available, an east image thumbnail's source address (e.g., /image?lat=44.90423&lon=−93.34609&type=east). At step 706, the application may set, if available, a south image thumbnail's source address (e.g., /image?lat=44.90423&lon=−93.34609&type=south). At step 708, the application may set, if available, a west image thumbnail's source address (e.g. /image?Iat=44.904231&lon=−93.346091&type=west). The image thumbnails may be stored, for example, in the database 106, stored (at least temporarily) in the client device 100, or retrieved from any other suitable location, such as the Internet or other available network or system. Accordingly, the source address for any given image thumbnail may be its directory address within the database 106 or at the client 100 or may be a directory or network address to another suitable location such as a directory address to storage within another system or a network address (e.g., URL) to a location from which the image thumbnail may be retrieved or requested. The one or more image thumbnails may be displayed to the user at client 100 at any suitable location and in any suitable organization, such as but not limited to, near or at a corner of the scene or display of the client 100. While described primarily herein with respect to an overhead image and north, east, south, and west images, other thumbnail images of the structure may additionally or alternatively be used, such as any number of oblique images of the structure taken from one or more angles or directions. Moreover, it is not required that all the thumbnail images described herein be provided, and the thumbnail images provided in any given scene are not limited to those described herein.

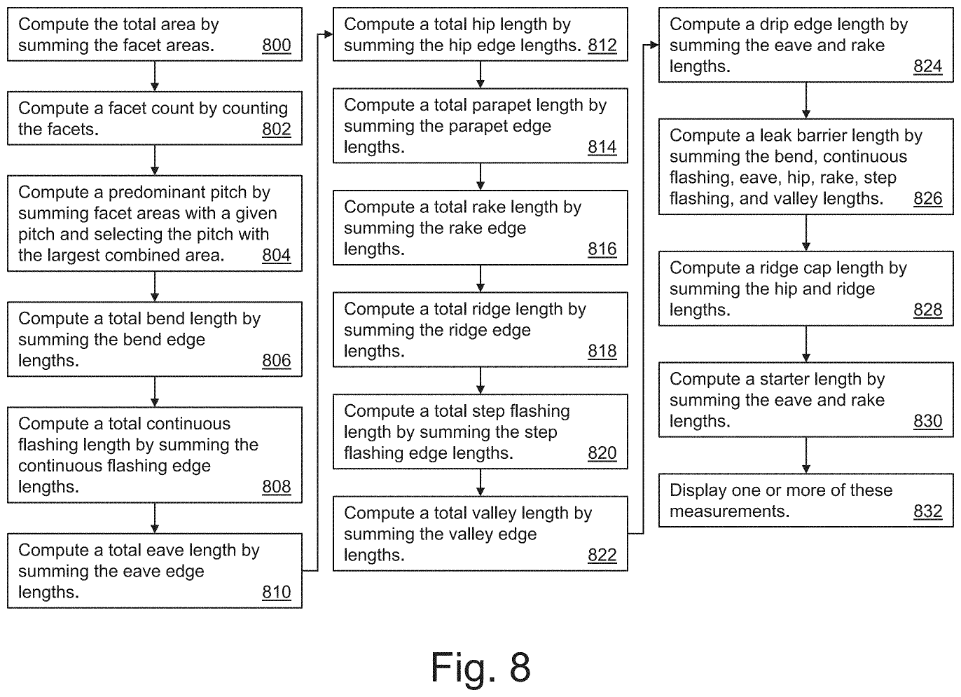

FIG. 8 is a flowchart for an example method of computing one or more roof measurements (e.g., step 214 in FIG. 2) for a 3D model. In it, the application may begin at step 800 by computing a total roof area by summing facet areas in the roof model. At step 802, the application may compute a facet count by counting the number of facets in the roof model. At step 804, the application may compute a predominant pitch by determining facet areas with the same or substantially the same pitch, and for each identified pitch or group of substantially the same pitches, summing the facet areas with the given pitch, and selecting the pitch of the identified pitches with the largest combined area. Whether facets have substantially the same pitch may be determined based on whether the facets have pitches that are within a certain tolerance of each other. The tolerance may be pre-assigned or predefined by or within the application, and in some cases may be modified or adjusted, including dynamically, by the user. At step 806, the application may compute a total bend edge length by summing the lengths of all edges identified as a bend. At step 808, the application may compute a total continuous flashing length by summing the lengths of all edges identified as a continuous flashing. At step 810, the application may compute a total eave length by summing the lengths of all edges identified as an cave. At step 812, the application may compute a total hip length by summing the lengths of all edges identified as a hip. At step 814, the application may compute a total parapet length by summing the lengths of all edges identified as a parapet. At step 816, the application may compute a total rake length by summing the lengths of all edges identified as a rake. At step 818, the application may compute a total ridge length by summing the lengths of all edges identified as a ridge. At step 820, the application may compute a total step flashing length by summing the lengths of all edges identified as a step flashing. At step 822, the application may compute a total valley length by summing the lengths of all edges identified as a valley. At step 824, the application may compute a drip edge length by summing the lengths of all edges identified as either an eave or rake. At step 826, the application may compute a leak barrier length by summing the lengths of all edges identified as any of a bend, continuous flashing, eave, hip, rake, step flashing, or valley. At step 828, the application may compute a ridge cap length by summing the lengths of all edges identified as either a hip or ridge. At step 830, the application may compute a starter length by summing the lengths of all edges identified as either an eave or rake. At step 832, the application may display one or more of these measurements at the client 100.

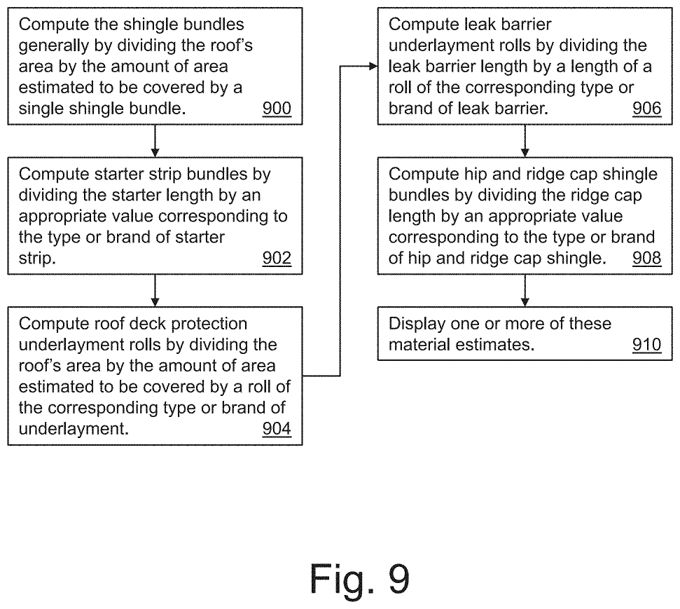

FIG. 9 is a flowchart for an example method of estimating roof materials (e.g., step 216 in FIG. 2). In it, the application may begin at step 900 by computing an amount of roofing shingle bundles (e.g., but not limited to, shingle bundles sold by GAF under the brand name Timberline®) desired or needed by, for example, generally dividing the roof's area (e.g., in square feet) by the amount of coverage area (e.g., also in square feet) provided by each bundle of the corresponding type or brand of shingles, optionally plus some tolerance of extra or spare shingles (e.g., extra bundle(s)). Other suitable methods for computing the amount of roofing shingle bundles may also or alternatively be used. At step 902, the application may compute an amount of starter strip shingle bundles or rolls (e.g., but not limited to, starter strip shingle bundles or rolls sold by GAF under the brand names WeatherBlocker™, Pro-Start®, or QuickStart®) desired or needed by, for example, generally dividing the starter length (e.g., in feet) by an appropriate value designated for the corresponding type or brand of starter strip shingle (e.g., by 100 for WeatherBlocker™, by 120 for Pro-Start®, or by 33 for QuickStart®), optionally plus some tolerance of extra or spare starter strip shingles (e.g., extra bundle(s) or roll(s)). Other suitable methods for computing the amount of starter strip shingle bundles or rolls may also or alternatively be used. At step 904, the application may compute an amount of rolls of roof deck protection underlayment (e.g., but not limited to, roof deck protection underlayment rolls sold by GAF under the brand names Shingle-Mate®, VersaShield®, Deck-Armor™, Tiger Paw™, or FeltBuster®) desired or needed by, for example, generally dividing the roof's area (e.g., in square feet) by the amount of area (e.g., also in square feet) estimated to be covered by each roll of the corresponding type or brand of underlayment (e.g., by 400 for Shingle-Mate®, by 350 for VersaShield®, or by 1,000 for Deck-Armor), optionally plus some tolerance of extra or spare underlayment (e.g., extra roll(s)). Other suitable methods for computing the amount of roof deck protection underlayment rolls may also or alternatively be used. At step 906, the application may compute an amount of rolls of leak barrier underlayment (e.g., but not limited to, leak barrier underlayment rolls sold by GAF under the brand names StormGuard® or WeatherWatch®) desired or needed by, for example, generally dividing the leak barrier length (e.g., in feet) by a length of a roll of the corresponding type or brand of leak barrier underlayment (e.g., by 66.7 for StormGuard® or by 50 for WeatherWatch®), optionally plus some tolerance of extra or spare underlayment (e.g., extra roll(s)). Other suitable methods for computing the amount of leak barrier underlayment rolls may also or alternatively be used. At step 608, the application may compute an amount of hip/ridge cap shingle bundles (e.g., but not limited to, hip/ridge cap shingle bundles sold by GAF under the brand names Seal-A-Ridge®, TimberTex®, TimberCrest®, Z® Ridge, or Ridglass®) desired or needed by, for example, generally dividing the ridge cap length (e.g., in feet) by an appropriate value designated for the corresponding type or brand of hip/ridge cap shingle (e.g., by 25 for Seal-A-Ridge®, by 20 for TimberTex® or TimberCrest®, or by 33 for Z® Ridge), optionally plus some tolerance of extra or spare hip/ridge cap shingles (e.g., extra bundle(s)). Other suitable methods for computing the amount of hip/ridge cap shingle bundles may also or alternatively be used. At step 910, the application may display one or more of these material estimates at the client 100.

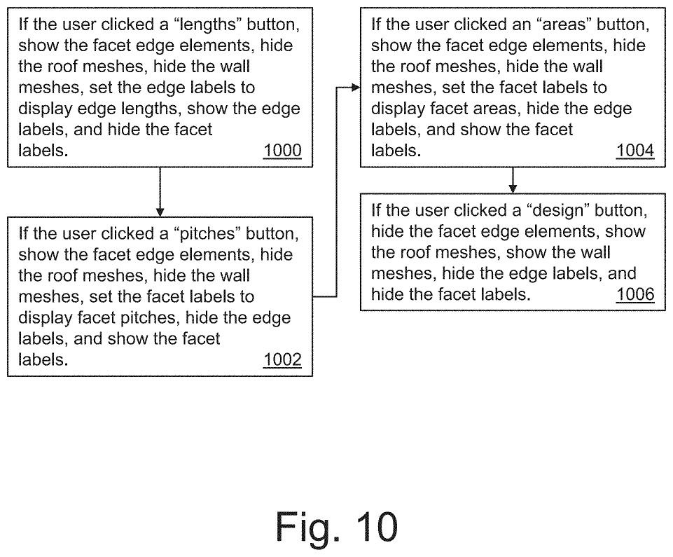

FIG. 10 is a flowchart for an example method of responding to user selection of mode controls or buttons (e.g., step 218 in FIG. 2). The application may enable the user to toggle or switch modes in the client 100 by selecting a button, choosing a mode from a dropdown menu, etc. For example, in the flowchart, the application may begin at step 1000 by determining if the user selected a “lengths” or other appropriately labeled button or control mechanism. If so, in the displayed scene, the application may, for example, one or more of show the facet edge elements, hide the roof meshes, hide the wall meshes, set the edge labels to display edge lengths, show the edge labels, and hide the facet labels. At step 1002, the application may determine if the user selected a “pitches” or other appropriately labeled button or control mechanism. If so, in the displayed scene, the application may, for example, one or more of show the facet edge elements, hide the roof meshes, hide the wall meshes, set the facet labels to display facet pitches, hide the edge labels, and show the facet labels. At step 1004, the application may determine if the user selected an “areas” or other appropriately labeled button or control mechanism. If so, in the displayed scene, the application may, for example, one or more of show the facet edge elements, hide the roof meshes, hide the wall meshes, set the facet labels to display facet areas, hide the edge labels, and show the facet labels. At step 1006, the application may determine if the user selected a “design” or other appropriately labeled button or control mechanism. If so, in the displayed scene, the application may, for example, one or more of hide the facet edge elements, show the roof meshes, show the wall meshes, hide the edge labels, and hide the facet labels. In some examples, instead of or in addition to separate mode buttons or controls, a single button or other control may be provided that cycles through the available modes when selected by the user.

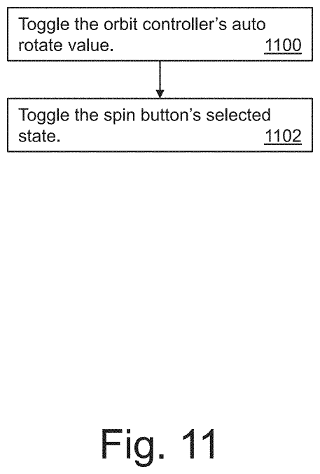

FIG. 11 is a flowchart for an example method of responding to user selection of a spin or rotate control or button (e.g., step 220 in FIG. 2). In it, the application may begin at step 1100 by toggling an auto rotate value of the orbit controller (e.g., between values indicative of whether the auto rotate is on or off). At step 1102, the application may toggle the spin button's selected state (e.g., between values indicative of whether the spin button is in an on or off state).

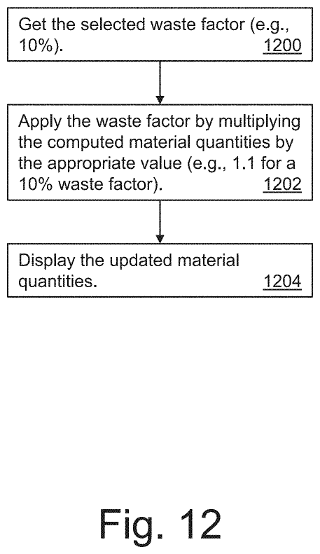

FIG. 12 is a flowchart for an example method of responding to user selection of a waste factor (e.g., step 222 in FIG. 2). The application may present one or more buttons, a dropdown menu, a fillable text input box, or other means in the client 100 to enable the user to enter or select a waste factor. In the flowchart, the application may begin at step 1200 by reading or getting the selected waste factor (e.g., 10%). At step 1202, the application may apply the waste factor by, for example, multiplying the material quantities by the appropriate value (e.g., 1.1 for a 10% waste factor). For example, if a roof requires 130 bundles of shingles with a waste factor 0%, it will require 130×1.2=156 bundles with a waste factor of 20%. Other algorithms for applying the waste factor may be used. At step 1204, the application may update the material quantities displayed to the user at the client 100.

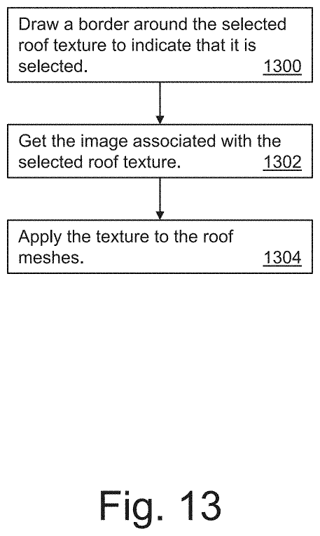

FIG. 13 is a flowchart for an example method of responding to user selection of a roof type or texture (e.g., step 224 in FIG. 2). The application may present one or more selectable images representing one or more roof types or textures in the client 100. In other embodiments, a list or other identification of one or more roof types or textures may be provided, such as in a dropdown menu, for selection by the user. When the user selects a roof type or texture, for example by selecting one of the images, the application may respond by applying the type or texture to the roof meshes displayed at the client 100. In the flowchart, the application may begin at step 1300 by drawing or highlighting a border around the selected roof type or texture to indicate that it is selected. At step 1302, the application may retrieve the image associated with the selected roof type or texture. At step 1304, the application may apply the type or texture to the roof meshes (e.g., using THREE.TextureLoader) displayed to the user at the client 100.

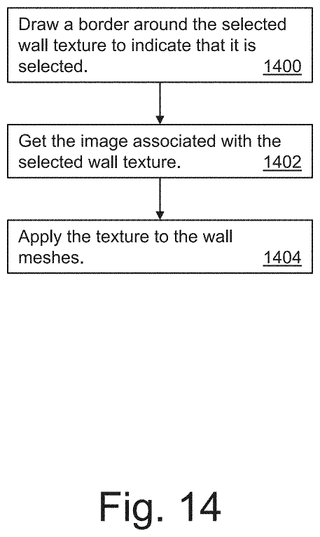

FIG. 14 is a flowchart for an example method of responding to user selection of a wall type or texture (e.g., step 226 in FIG. 2). The application may present one or more selectable images representing one or more wall types or textures in the client 100. In other embodiments, a list or other identification of one or more wall types or textures may be provided, such as in a dropdown menu, for selection by the user. When the user selects a wall type or texture, for example by selecting one of the images, the application may respond by applying the type or texture to the wall meshes displayed at the client 100. In the flowchart, the application may begin at step 1400 by drawing or highlighting a border around the selected wall type or texture to indicate that it is selected. At step 1402, the application may retrieve the image associated with the selected wall type or texture. At step 1404, the application may apply the type or texture to the wall meshes (e.g., using THREE.TextureLoader) displayed to the user at the client 100.

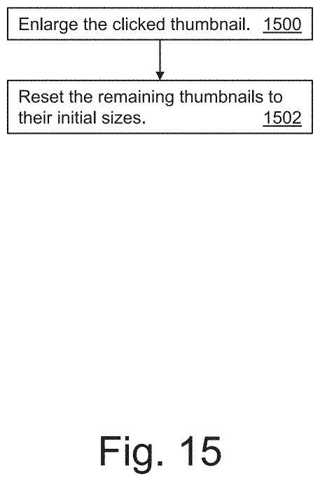

FIG. 15 is a flowchart for an example method of responding to user selection of an image thumbnail (e.g., step 228 in FIG. 2). In it, the application may begin at step 1500 by enlarging the clicked thumbnail (e.g., to 1.5 times its original size, to 2 times its original size, to 3 times its original size, or more). At step 1502, the application may reset the remaining thumbnails to their initial sizes.

FIG. 16 is a table of example edge colors for an embodiment of the present disclosure. For each edge type, the table may list the edge type (e.g., ridge), an associated color (e.g., red), and a hex color value (e.g., E40514). The table in FIG. 16 is only an example of edge types and associated colors, and any color may be associated with one or more edge types.

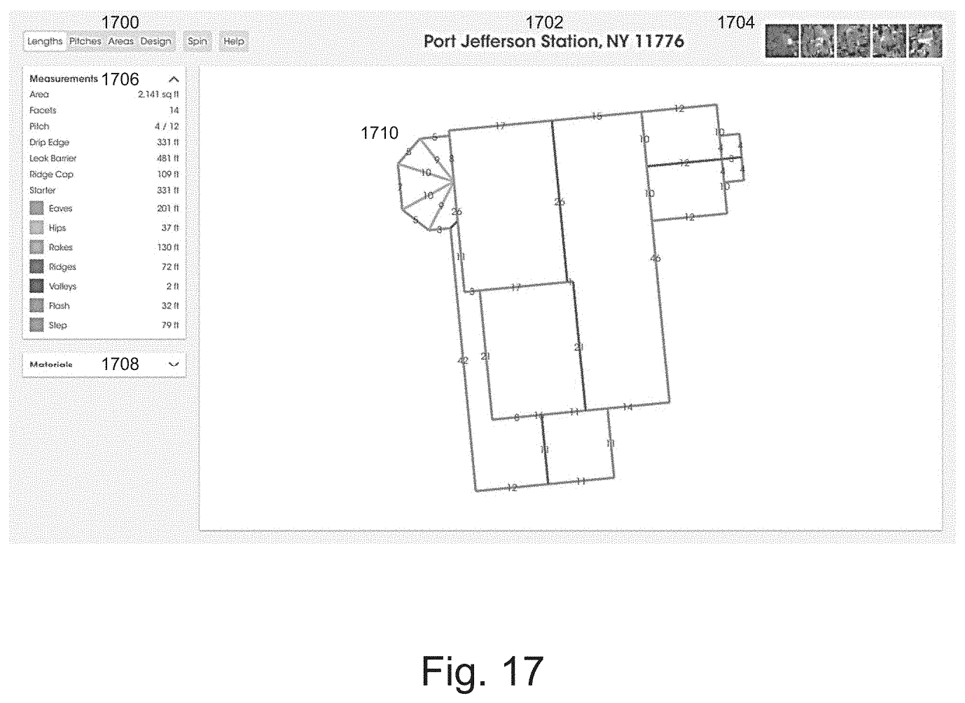

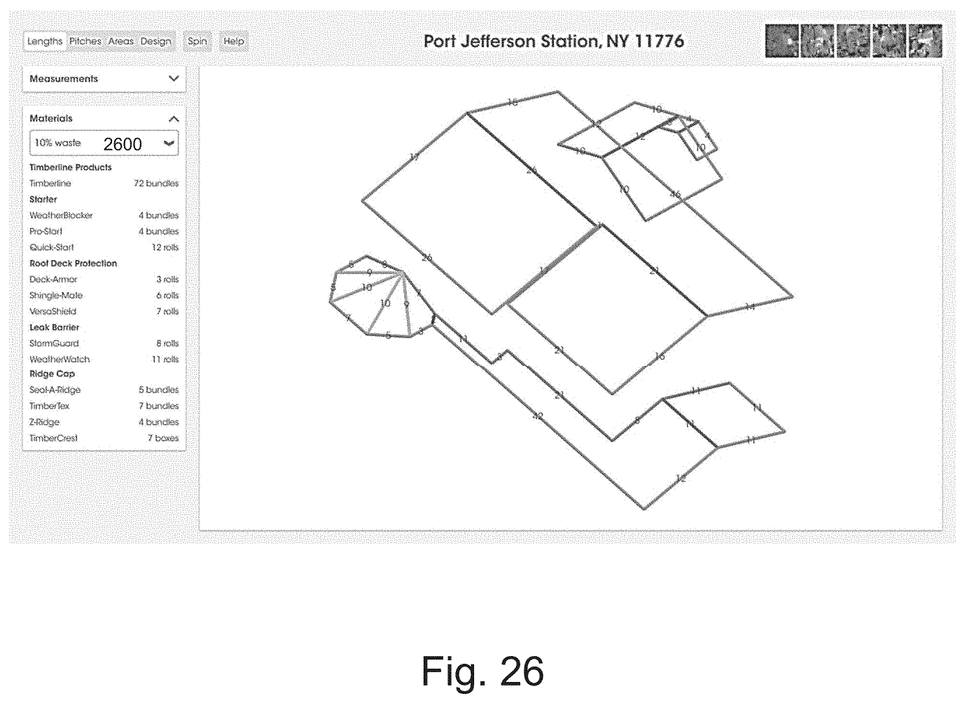

FIG. 17 is screenshot of an example interactive interface for displaying the scene, structure measurements, materials, and designs, described above, at the client 100. It shows an overhead structure view with facet edge lengths. The interface may include controls 1700. These controls may include one or more mode buttons (e.g., “lengths,” “pitches,” “areas,” and “design” buttons as described above), a “spin” button as described above, and a “help” button, which upon selection may provide useful information or assistance to the user. The interface may include an address 1702. The interface may include image thumbnails 1704 of the structure, as also described above. The interface may enlarge a thumbnail if the user selects it. The interface may include a measurements panel 1706 showing, for example, one or more of area, facets, pitch(es), drip edge(s), leak barrier(s), etc. relating to the roof model displayed (e.g., 1710) as described above, and a materials panel 1708 showing, for example, estimates for one or more of roofing shingles, starter strip shingles, roof deck protection underlayment, leak barrier underlayment, hip/ridge cap shingles, etc. as described above (see also FIG. 26 infra). The interface may support expanding and collapsing these panels. The interface may include an interactive 3D model 1710 as at least part of the scene described above. As previously described, this model 1710 may contain facet edge elements representing roof facet edges. These facet edge elements may be colored to indicate edge type. The edge types and corresponding colors may be identified in the measurements panel 1706, as illustrated, or at any other suitable location of the interface. The model 1710 may have edge labels and facet labels. In “lengths” mode, the edge labels may display edge lengths. In “pitches” mode, the facet labels may display facet pitches. In “areas” mode, the facet labels may display facet areas. For a given view, the interface may hide some labels to prevent clutter. The user may be able to rotate the model using, for example, the left mouse button, pan the model using, for example, the right mouse button, and zoom using, for example, the scroll wheel. Alternatively, on a touchscreen, the user may be able to rotate the model with, for example, one finger, pan the model with, for example, two fingers, and zoom, for example, by pinching with two fingers.

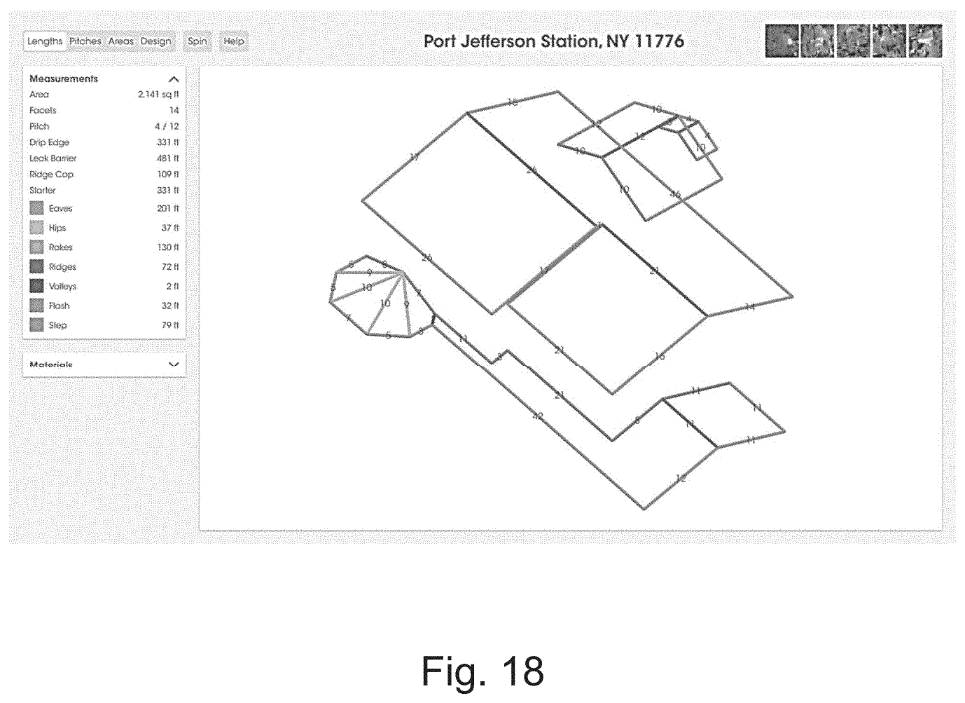

FIG. 18 is another screenshot of an example interface, which may include some or all of the same features as the interface described above with respect to FIG. 17. In FIG. 18, a tilted structure view with facet edge length labels is shown.

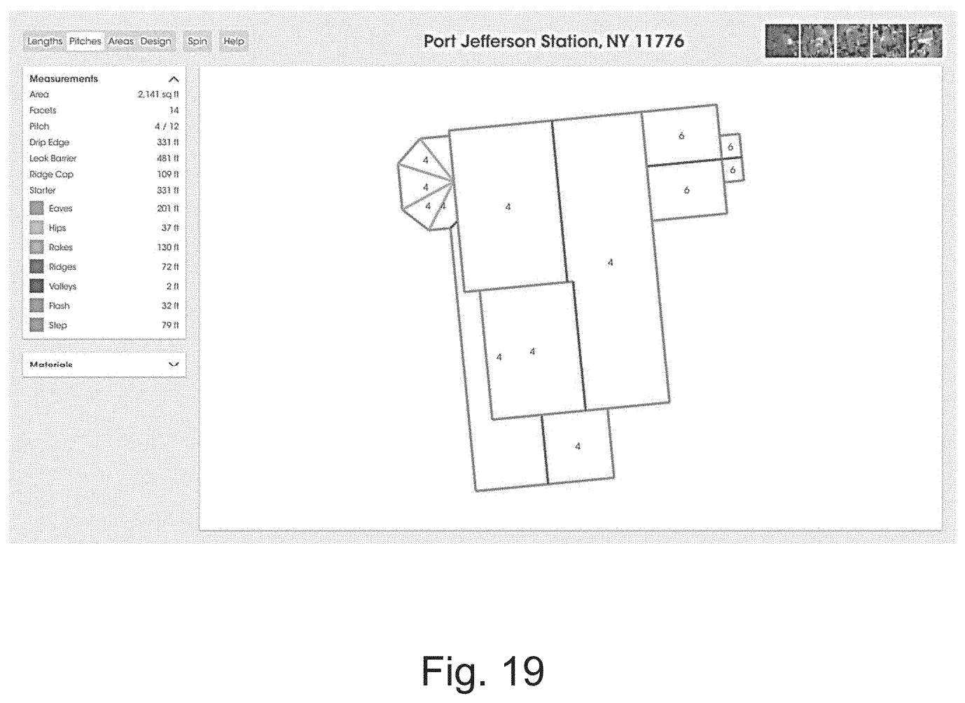

FIG. 19 is another screenshot of an example interface, which may include some or all of the same features as the interface described above with respect to FIG. 17. In FIG. 19, an overhead structure view with facet pitch labels is shown.

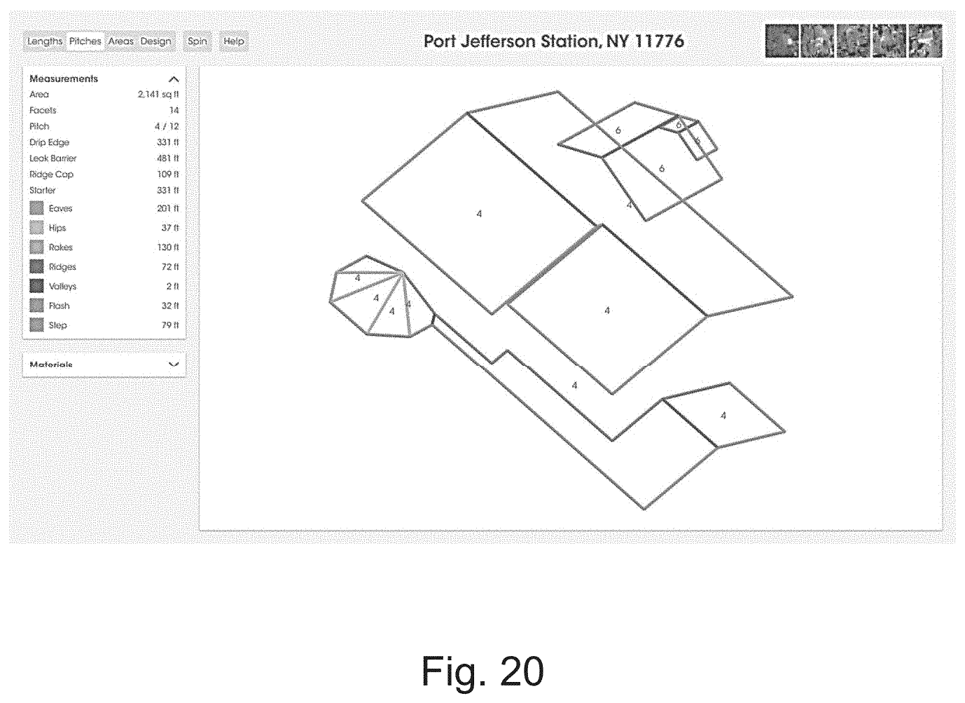

FIG. 20 is another screenshot of an example interface, which may include some or all of the same features as the interface described above with respect to FIG. 17. In FIG. 20, a tilted structure view with facet pitch labels is shown.

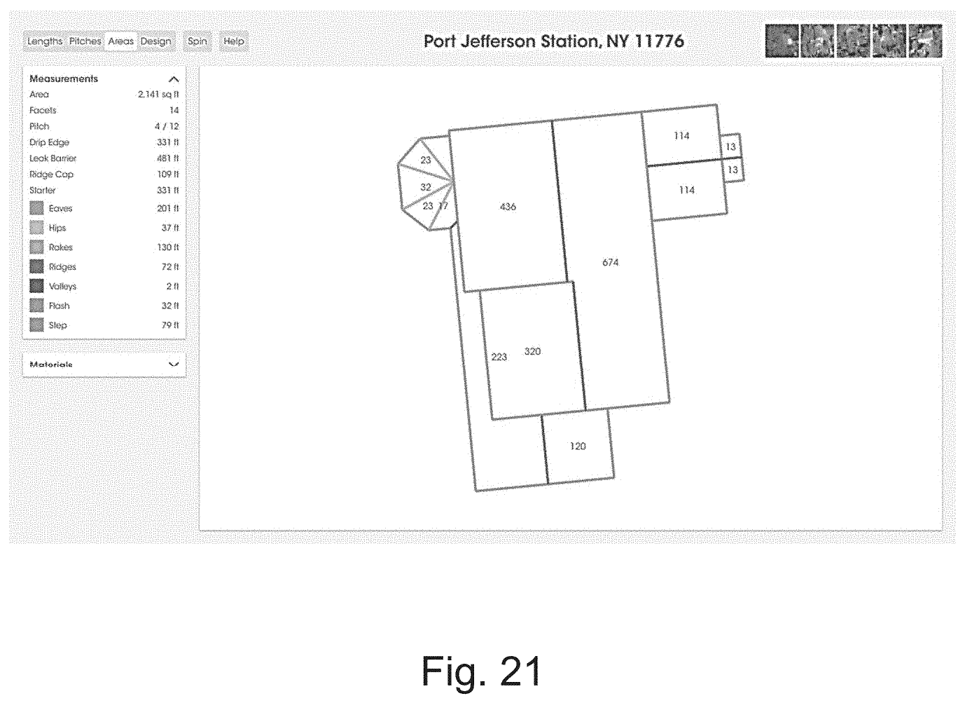

FIG. 21 is another screenshot of an example interface, which may include some or all of the same features as the interface described above with respect to FIG. 17. In FIG. 21, an overhead structure view with facet area labels is shown.

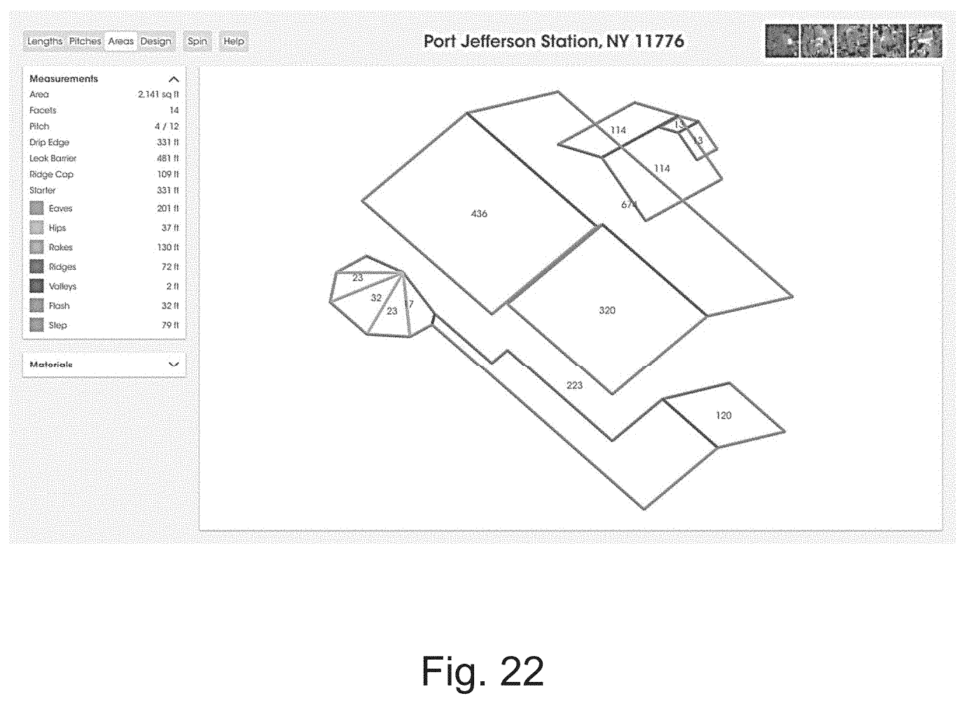

FIG. 22 is another screenshot of an example interface, which may include some or all of the same features as the interface described above with respect to FIG. 17. In FIG. 22, a tilted structure view with facet area labels is shown.

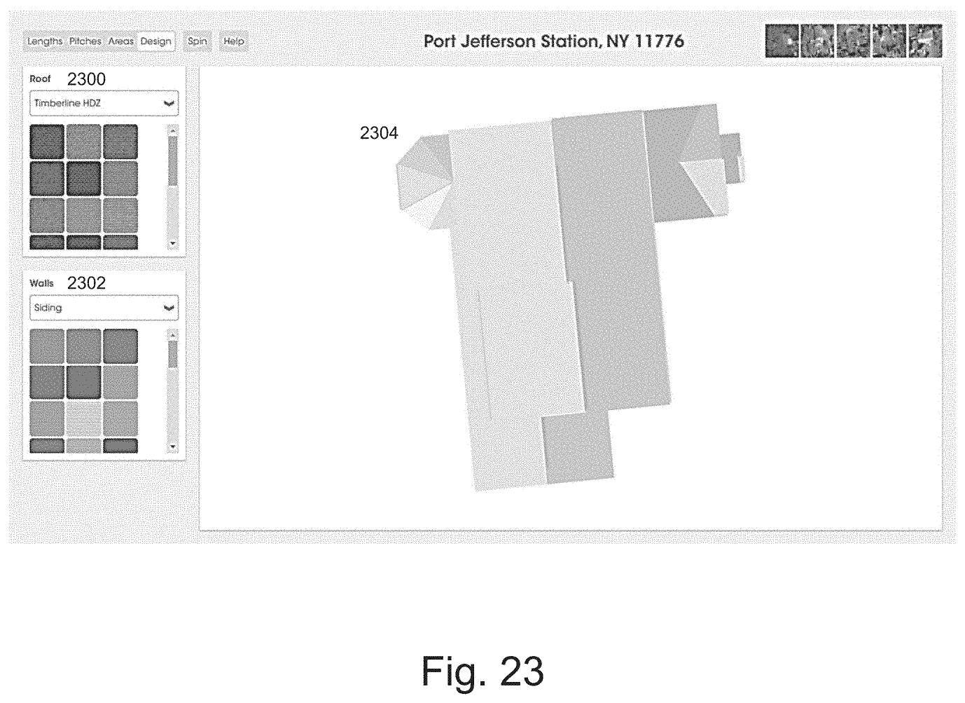

FIG. 23 is another screenshot of an example interface, which may include some or all of the same features as the interface described above with respect to FIG. 17. In FIG. 23, an overhead structure design view is shown. The interface may include a roof panel 2300 and a wall panel 2302, generated as described above. The roof panel 2300 may include a dropdown menu and/or other suitable selection mechanism for selecting a roofing type and/or texture. The roof panel 2300 may display one or more roof type or texture images, as described above. The wall panel 2302 may include a dropdown menu and/or other suitable selection mechanism for selecting a wall type and/or texture (e.g., siding, brick, paint). The wall panel 2302 may display one or more wall type or texture images, as described above. The interface may include an interactive 3D model 2304 as at least part of the scene described above. As previously described, this model 2304 may include roof meshes and/or wall meshes. When the user selects a texture in the roof panel 2300, the application may apply the texture to the roof meshes. When the user selects a texture in the wall panel 2302, the application may apply the texture to the wall meshes. As in the other modes, in design mode, the user may be able to rotate, pan, and zoom the structure model, using any suitable means as described herein.

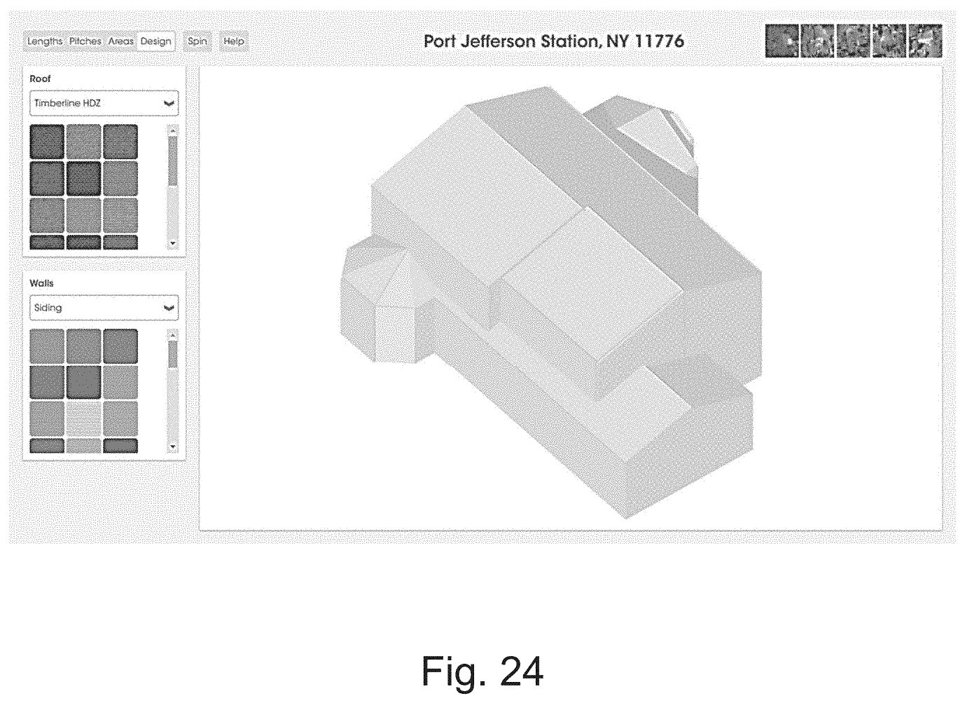

FIG. 24 is another screenshot of an example interface, which may include some or all of the same features as the interfaces described above with respect to FIGS. 17 and 23. In FIG. 24, a tilted structure design view is shown. In this example, the user has not yet selected a roofing or wall type or texture.

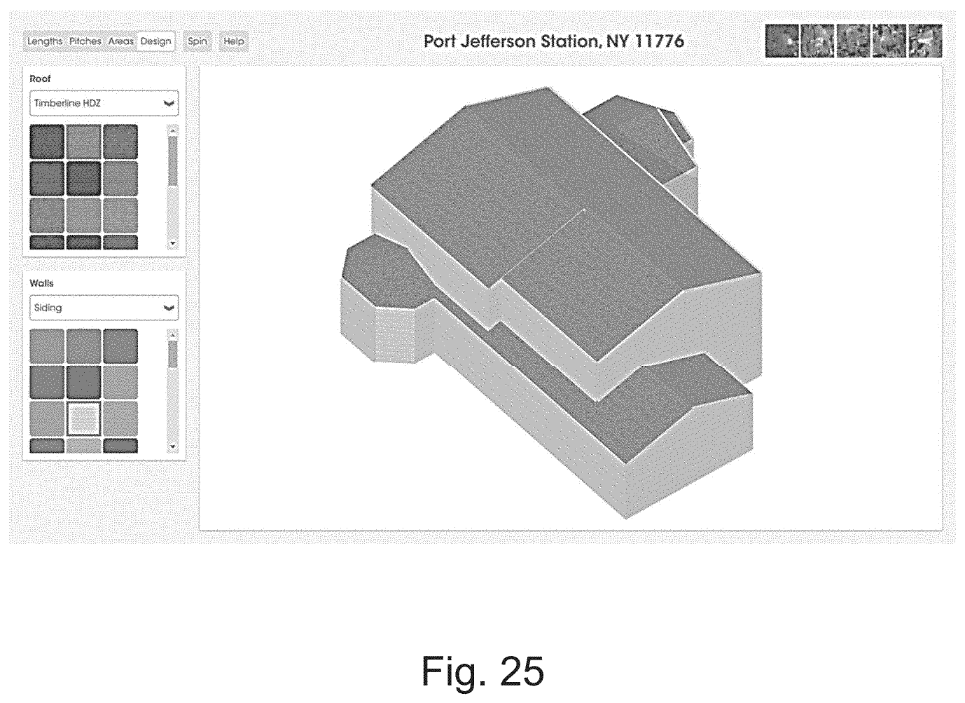

FIG. 25 is another screenshot of an example interface, which may include some or all of the same features as the interfaces described above with respect to FIGS. 17 and 23. In FIG. 25, a tilted structure design view is shown. In this example, the user has selected a roof type and/or texture from the roof panel 2300 and a wall type and/or texture from the wall panel 2302. The application has applied the corresponding textures to the interactive 3D model 2304.

FIG. 26 is another screenshot of an example interface, which may include some or all of the same features as the interfaces described above with respect to FIG. 17. In FIG. 26, a tilted structure view with facet edge length labels is shown. In this example, the user has expanded the materials panel 1708 showing material estimates, as previously described. The interface may include a waste factor dropdown menu 2600 and/or other suitable selection mechanism or input mechanism. As described above, if the user selects a different waste factor, the application may adjust the material estimates accordingly.

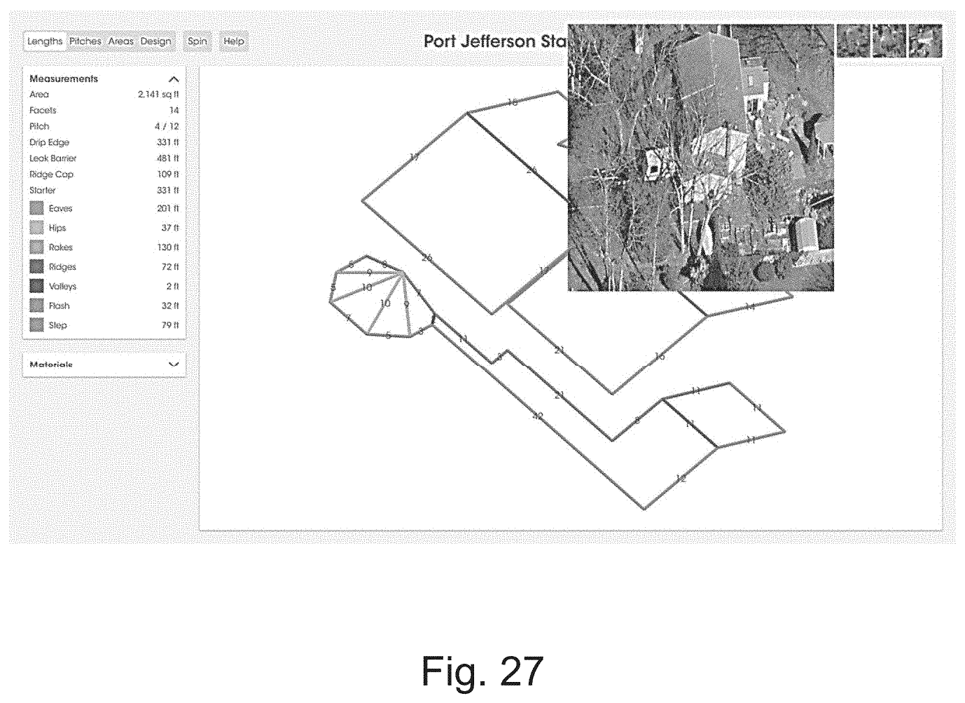

FIG. 27 is another screenshot of an example interface, which may include some or all of the same features as the interfaces described above with respect to FIG. 17. In FIG. 27, a tilted structure view with facet edge length labels is shown. In this example, the user has selected an image thumbnail 1704, and the application has enlarged it relative to its original size and/or the size of the other image thumbnails, if provided.

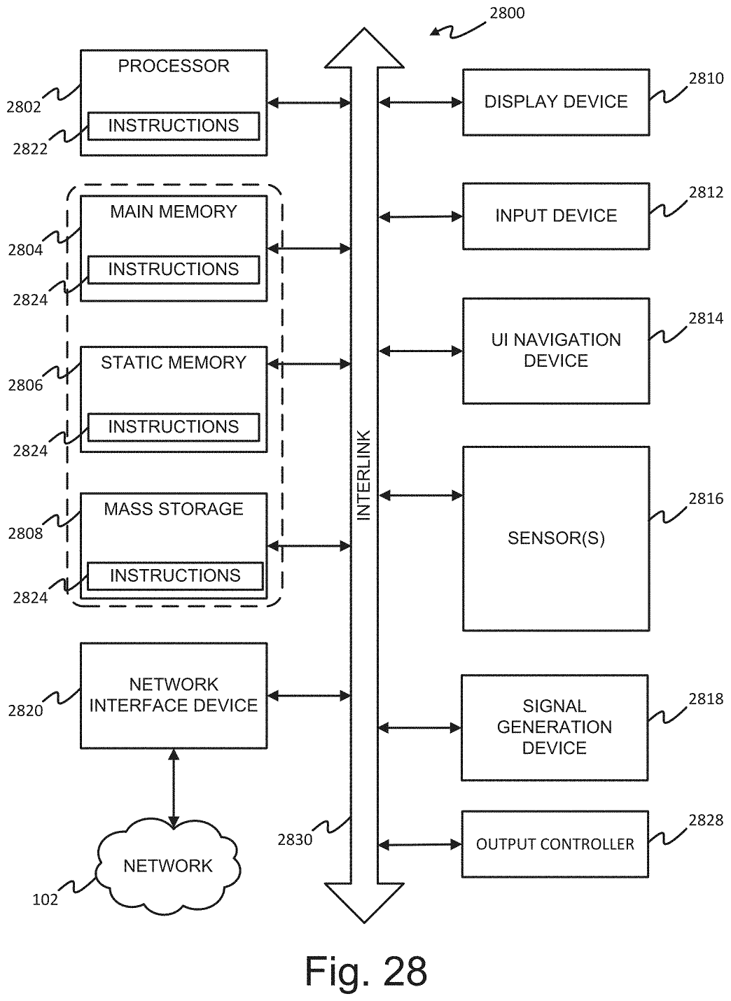

FIG. 28 illustrates a block diagram schematic of various example components of an example machine 2800 that can be used as, for example, client 100 and/or server 104. Examples, as described herein, can include, or can operate by, logic or a number of components, modules, or mechanisms in machine 2800. Modules may be hardware, software, or firmware communicatively coupled to one or more processors in order to carry out the operations described herein. Generally, circuitry (e.g., processing circuitry) is a collection of circuits implemented in tangible entities of machine 2800 that include hardware (e.g., simple circuits, gates, logic, etc.). Circuitry membership can be flexible over time. Circuitries include members that can, alone or in combination, perform specified operations when operating. In some examples, hardware of the circuitry can be immutably designed to carry out a specific operation (e.g., hardwired). In some examples, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions permit embedded hardware (e.g., the execution units or a loading mechanism) to create members of the circuitry in hardware via the variable connections to carry out portions of the specific operation when in operation. Accordingly, in some examples, the machine readable medium elements are part of the circuitry or are communicatively coupled to the other components of the circuitry when the device is operating. In some examples, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional and/or more specific examples of components with respect to machine 2800 follow.

In some embodiments, machine 2800 can operate as a standalone device or can be connected (e.g., networked) to other machines. In a networked deployment, machine 2800 can operate in the capacity of a server machine, a client machine, or both in server-client network environments. In some examples, machine 2800 can act as a peer machine in a peer-to-peer (P2P) (or other distributed) network environment. Machine 2800 can be or include a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 2800 can include a hardware processor 2802 (e.g., a central processing unit (CPU), a graphics processing unit (GPU), a hardware processor core, or any combination thereof) and a main memory 2804, a static memory (e.g., memory or storage for firmware, microcode, a basic-input-output (BIOS), unified extensible firmware interface (UEFI), etc.) 2806, and/or mass storage 2808 (e.g., hard drives, tape drives, flash storage, or other block devices) some or all of which can communicate with each other via an interlink (e.g., bus) 2830. Machine 2800 can further include a display device 2810 and an input device 2812 and/or a user interface (UI) navigation device 2814. Example input devices and UI navigation devices include, without limitation, one or more buttons, a keyboard, a touch-sensitive surface, a stylus, a camera, a microphone, etc.). In some examples, one or more of the display device 2810, input device 2812, and UI navigation device 2814 can be a combined unit, such as a touch screen display. Machine 2800 can additionally include a signal generation device 2818 (e.g., a speaker), a network interface device 2820, and one or more sensors 2816, such as a global positioning system (GPS) sensor, compass, accelerometer, or other sensor. Machine 2800 can include an output controller 2828, such as a serial (e.g., universal serial bus (USB), parallel, or other wired or wireless (e.g., infrared (IR), NFC, etc.) connection to communicate or control one or more peripheral devices (e.g., a printer, card reader, etc.).

Processor 2802 can correspond to one or more computer processing devices or resources. For instance, processor 2802 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 2802 can be provided as a microprocessor, Central Processing Unit (CPU), or plurality of microprocessors or CPUs that are configured to execute instructions sets stored in an internal memory 2822 and/or memory 2804, 2806, 2808.

Any of memory 2804, 2806, and 2808 can be used in connection with the execution of application programming or instructions by processor 2802 for performing any of the functionality or methods described herein, and for the temporary or long-term storage of program instructions or instruction sets 2824 and/or other data for performing any of the functionality or methods described herein. Any of memory 2804, 2806, 2808 can comprise a computer readable medium that can be any medium that can contain, store, communicate, or transport data, program code, or instructions 2824 for use by or in connection with machine 2800. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), a solid-state storage device, in general, a compact disc read-only memory (CD-ROM), or other optical or magnetic storage device. As noted above, computer-readable media includes, but is not to be confused with, computer-readable storage medium, which is intended to cover all physical, non-transitory, or similar embodiments of computer-readable media.

Network interface device 2820 includes hardware to facilitate communications with other devices over a communication network, such as network 102, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 2820 can include an Ethernet port or other physical jack, a Wi-Fi card, a Network Interface Card (NIC), a cellular interface (e.g., antenna, filters, and associated circuitry), or the like. In some examples, network interface device 2820 can include one or more antennas to wirelessly communicate using at least one of single-input multiple-output (SIMO), multiple-input multiple-output (MIMO), or multiple-input single-output (MISO) techniques.

As indicated above, machine 2800 can include one or more interlinks or buses 2830 operable to transmit communications between the various hardware components of the machine. A system bus 2830 can be any of several types of commercially available bus structures or bus architectures.

### ADDITIONAL EXAMPLES

Example 1 includes subject matter relating to a non-transitory computer readable medium comprising executable program code, that when executed by one or more processors, causes the one or more processors to: obtain a digital roof model corresponding to a roof of a structure; determine facet edge elements for a digital 3D model of the structure based on the digital roof model, the facet edge elements representing roof facet edges of the roof; determine roof facet meshes for the digital 3D model based on the digital roof model, the roof facet meshes representing roof facets of the roof; and provide an electronic interface enabling a user to view at least a portion of the digital 3D model, the at least a portion comprising the facet edge elements, the roof facet meshes, or both the facet edge elements and roof facet meshes, the electronic interface enabling the user to interactively manipulate the at least a portion of the digital 3D model to at least one of alter a view of the at least a portion of the digital 3D model or alter characteristics of the at least a portion of the digital 3D model.

In Example 2, the subject matter of Example 1 optionally includes wherein the roof model defines, for each roof facet, each vertex of the roof facet.

In Example 3, the subject matter of Example 2 optionally includes wherein the roof model further defines, for each roof facet, an edge type for each roof facet edge of the roof facet and a normal for the roof facet.

In Example 4, the subject matter of any of Examples 1 to 3 optionally includes wherein determining facet edge elements for the digital 3D model comprises, for each roof facet: determining the roof facet edges corresponding to the facet based on the vertices of the roof facet; and for one or more of the determined roof facet edges: constructing a digital facet edge element representing the roof facet edge based on two of the vertices of the roof facet, wherein a length of the digital facet edge element corresponds to a distance between the two vertices; and orienting and positioning the digital facet edge element to match a vector between the two vertices.

In Example 5, the subject matter of Example 4 optionally includes wherein determining facet edge elements for the digital 3D model further comprises, for each of the one or more of the determined roof facet edges, setting a color of the corresponding facet edge element based on an edge type for the corresponding roof facet edge.

In Example 6, the subject matter of Example 4 or 5 optionally includes wherein determining facet edge elements for the digital 3D model further comprises, for each of the one or more of the determined roof facet edges, providing an edge label for the corresponding roof facet edge, the edge label identifying a length of the corresponding roof facet edge.

In Example 7, the subject matter of any of Examples 2 to 6 optionally includes wherein determining roof facet meshes for the digital 3D model comprises, for each roof facet: determining a facet plane for the roof facet based on a normal for the roof facet; determining snapped vertices in the facet plane corresponding to the vertices of the roof facet; and constructing a roof facet mesh for the roof facet based on the snapped vertices in the facet plane.

In Example 8, the subject matter of Example 7 optionally includes wherein determining roof facet meshes for the digital 3D model further comprises, for each of the roof facet meshes, providing a facet label for the corresponding facet mesh, the facet label identifying at least one of an area of the corresponding facet or a pitch of the corresponding facet.

In Example 9, the subject matter of any of Examples 1 to 8 optionally includes wherein enabling the user to interactively manipulate the at least a portion of the digital 3D model comprises enabling the user to select at least one of a roof type or roof texture and view the at least a portion of the digital 3D model with the selected at least one of the roof type or roof texture applied to one or more of the roof facet meshes.

In Example 10, the subject matter of any of Examples 1 to 9 optionally includes wherein the executable code, when executed by the one or more processors, causes the one or more processors to further construct wall meshes for the digital 3D model, the wall meshes representing walls for the structure.

In Example 11, the subject matter of Example 10 optionally includes wherein constructing wall meshes for the digital 3D model comprises: determining a ground level for the digital 3D model based on the digital roof model; and for each of one or more roof facet edges determined to be connected to a single roof facet: determining a wall vertex list comprising a first vertex of the roof facet edge, a second vertex of the roof facet edge, a third vertex at the ground level corresponding to the first vertex, and a fourth vertex at the ground level corresponding to the second vertex; and constructing a wall mesh based on the vertex list.

In Example 12, the subject matter of Example 10 or 11 optionally includes wherein: the at least a portion of the digital 3D model further comprises the wall meshes; and enabling the user to interactively manipulate the at least a portion of the digital 3D model comprises enabling the user to select at least one of a wall type or wall texture and view the at least a portion of the digital 3D model with the selected at least one of the wall type or wall texture applied to one or more of the wall meshes.

In Example 13, the subject matter of Example 12 optionally includes wherein enabling the user to interactively manipulate the at least a portion of the digital 3D model comprises enabling the user to select at least one of a roof type or roof texture and view the at least a portion of the digital 3D model with the selected at least one of the roof type or roof texture applied to one or more of the roof facet meshes.

In Example 14, the subject matter of any of Examples 1 to 13 optionally includes wherein the executable code, when executed by the one or more processors, causes the one or more processors to further determine a material estimate for each of one or more of roofing shingles, starter strip shingles, roof deck protection underlayment, leak barrier underlayment, or hip/ridge cap shingles based on the digital roof model.

In Example 15, the subject matter of Example 14 optionally includes wherein the executable code, when executed by the one or more processors, causes the one or more processors to further display each material estimate in the electronic interface.

In Example 16, the subject matter of Example 14 or 15 optionally includes wherein the executable code, when executed by the one or more processors, causes the one or more processors to further: enable the user to select a waste factor; and update each material estimate based on the selected waste factor.

Example 17 includes subject matter relating to a computer-implemented method for providing an interactive digital 3D model of a structure, the method comprising: obtaining a digital roof model corresponding to a roof of the structure; at least one of: constructing roof facet edges for the interactive digital 3D model based on the digital roof model, the roof facet edges representing facet edges of the roof; or constructing roof facet meshes for the interactive digital 3D model based on the digital roof model, the roof facet meshes representing roof facets of the roof; determining a ground level for the interactive digital 3D model based on the digital roof model, and for each roof facet edge determined to be connected to a single roof facet: determining a wall vertex list comprising a first vertex of the roof facet edge, a second vertex of the roof facet edge, a third vertex at the ground level corresponding to the first vertex, and a fourth vertex at the ground level corresponding to the second vertex; and constructing a wall mesh based on the vertex list; and providing an electronic interface enabling a user to view the interactive digital 3D model, the electronic interface enabling the user to manipulate the interactive digital 3D model, wherein manipulating the interactive digital 3D model comprises at least one of: enabling the user to select at least one of a roof type or roof texture and view the interactive digital 3D model with the selected at least one of the roof type or roof texture applied to one or more of the roof facet meshes; or enabling the user to select at least one of a wall type or wall texture and view the interactive digital 3D model with the selected at least one of the wall type or wall texture applied to one or more wall mesh.

In Example 18, the subject matter of Example 17 optionally includes determining a material estimate for each of one or more of roofing shingles, starter strip shingles, roof deck protection underlayment, leak barrier underlayment, or hip/ridge cap shingles based on the digital roof model; and displaying each material estimate in the electronic interface.

In Example 19, the subject matter of Example 18 optionally includes updating each material estimate based on a waste factor selected by the user.

In Example 20, the subject matter of any of Examples 17 to 19 optionally includes wherein: constructing roof facet edges for the interactive digital 3D model comprises, for each roof facet of the roof: determining the facet edges corresponding to the facet based on vertices for the roof facet in the digital roof model; and for one or more of the determined roof facet edges: constructing a digital facet edge element representing the roof facet edge based on two of the vertices of the roof facet, wherein a length of the digital facet edge element corresponds to a distance between the two vertices; and orienting and positioning the digital facet edge element to match a vector between the two vertices; and constructing roof facet meshes for the interactive digital 3D model comprises, for each roof facet of the roof: determining a facet plane for the roof facet based on a normal for the roof facet; determining snapped vertices in the facet plane corresponding to the vertices for the roof facet in the digital roof model; and constructing a roof facet mesh for the roof facet based on the snapped vertices in the facet plane.

Example 21 includes subject matter relating to a non-transitory computer readable medium comprising executable program code, that when executed by one or more processors, causes the one or more processors to: obtain a digital roof model corresponding to a roof of a structure; at least one of: construct facet edge elements for a digital 3D model of the structure based on the digital roof model, the facet edge elements representing roof facet edges of the roof; or construct roof facet meshes for the digital 3D model based on the digital roof model, the roof facet meshes representing roof facets of the roof; and provide an electronic interface enabling a user to view the at least one of the constructed facet edge elements or the constructed roof facet meshes of the digital 3D model, the electronic interface enabling the user to interactively manipulate the digital 3D model to at least one of alter a view of the digital 3D model or alter characteristics of the digital 3D model.

### Additional Notes

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment, or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Various embodiments of the present disclosure have been described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a machine having a particular function, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the disclosure.

Additionally, although flowcharts have been used herein to illustrate methods comprising sequential steps or processes having a particular order of operations, many of the steps or operations in the flowcharts illustrated herein can be performed in parallel or concurrently, and the flowcharts should be read in the context of the various embodiments of the present disclosure. In addition, the order of the method steps or process operations illustrated in any particular flowchart herein may be rearranged for some embodiments. Similarly, a method or process illustrated in any particular flow chart herein could have additional steps or operations not included therein or fewer steps or operations than those shown. Moreover, a method step may correspond to a method, a function, a procedure, a subroutine, a subprogram, etc.

Although specific amounts, distances, percentages, thresholds, or other values are provided as examples herein, other suitable amounts, distances, percentages, thresholds, or other values may be used and are contemplated by the present disclosure.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrases “at least one of [X] and [Y]” and “at least one of [X] or [Y],” where X and Y are different components that may be included in an embodiment of the present disclosure, mean that the embodiment could include component X without component Y, the embodiment could include the component Y without component X, or the embodiment could include both components X and Y. Similarly, when used with respect to three or more components, such as “at least one of [X], [Y], and [Z]” or “at least one of [X], [Y], or [Z],” the phrases mean that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A non-transitory computer readable medium comprising executable code, that when executed by one or more processors, causes the one or more processors to:
obtain a digital roof model corresponding to a roof of a structure;
determine facet edge elements for a digital 3D model of the structure based on the digital roof model, the facet edge elements representing roof facet edges of the roof;
determine roof facet meshes for the digital 3D model based on the digital roof model, the roof facet meshes representing roof facets of the roof; and
provide an electronic interface enabling a user to view at least a portion of the digital 3D model, the at least a portion comprising the facet edge elements, the roof facet meshes, or both the facet edge elements and roof facet meshes, the electronic interface enabling the user to interactively manipulate the at least a portion of the digital 3D model to at least one of alter a view of the at least a portion of the digital 3D model or alter characteristics of the at least a portion of the digital 3D model.

2. The non-transitory computer readable medium of claim 1, wherein the roof model defines, for each roof facet, each vertex of the roof facet.

3. The non-transitory computer readable medium of claim 2, wherein the roof model further defines, for each roof facet, an edge type for each roof facet edge of the roof facet and a normal for the roof facet.

4. The non-transitory computer readable medium of claim 2, wherein determining facet edge elements for the digital 3D model comprises, for each roof facet:
determining the roof facet edges corresponding to the facet based on the vertices of the roof facet; and
for one or more of the determined roof facet edges:
constructing a digital facet edge element representing the roof facet edge based on two of the vertices of the roof facet, wherein a length of the digital facet edge element corresponds to a distance between the two vertices; and
orienting and positioning the digital facet edge element to match a vector between the two vertices.

5. The non-transitory computer readable medium of claim 4, wherein determining facet edge elements for the digital 3D model further comprises, for each of the one or more of the determined roof facet edges, setting a color of the corresponding facet edge element based on an edge type for the corresponding roof facet edge.

6. The non-transitory computer readable medium of claim 4, wherein determining facet edge elements for the digital 3D model further comprises, for each of the one or more of the determined roof facet edges, providing an edge label for the corresponding roof facet edge, the edge label identifying a length of the corresponding roof facet edge.

7. The non-transitory computer readable medium of claim 2, wherein determining roof facet meshes for the digital 3D model comprises, for each roof facet:
determining a facet plane for the roof facet based on a normal for the roof facet;
determining snapped vertices in the facet plane corresponding to the vertices of the roof facet; and
constructing a roof facet mesh for the roof facet based on the snapped vertices in the facet plane.

8. The non-transitory computer readable medium of claim 7, wherein determining roof facet meshes for the digital 3D model further comprises, for each of the roof facet meshes, providing a facet label for the corresponding facet mesh, the facet label identifying at least one of an area of the corresponding facet or a pitch of the corresponding facet.

9. The non-transitory computer readable medium of claim 7, wherein enabling the user to interactively manipulate the at least a portion of the digital 3D model comprises enabling the user to select at least one of a roof type or roof texture and view the at least a portion of the digital 3D model with the selected at least one of the roof type or roof texture applied to one or more of the roof facet meshes.

10. The non-transitory computer readable medium of claim 1, wherein the executable code, when executed by the one or more processors, causes the one or more processors to further construct wall meshes for the digital 3D model, the wall meshes representing walls for the structure.

11. The non-transitory computer readable medium of claim 10, wherein constructing wall meshes for the digital 3D model comprises:
determining a ground level for the digital 3D model based on the digital roof model; and
for each of one or more roof facet edges determined to be connected to a single roof facet:
determining a wall vertex list comprising a first vertex of the roof facet edge, a second vertex of the roof facet edge, a third vertex at the ground level corresponding to the first vertex, and a fourth vertex at the ground level corresponding to the second vertex; and
constructing a wall mesh based on the vertex list.

12. The non-transitory computer readable medium of claim 11, wherein:
the at least a portion of the digital 3D model further comprises the wall meshes; and
enabling the user to interactively manipulate the at least a portion of the digital 3D model comprises enabling the user to select at least one of a wall type or wall texture and view the at least a portion of the digital 3D model with the selected at least one of the wall type or wall texture applied to one or more of the wall meshes.

13. The non-transitory computer readable medium of claim 12, wherein enabling the user to interactively manipulate the at least a portion of the digital 3D model comprises enabling the user to select at least one of a roof type or roof texture and view the at least a portion of the digital 3D model with the selected at least one of the roof type or roof texture applied to one or more of the roof facet meshes.

14. The non-transitory computer readable medium of claim 1, wherein the executable code, when executed by the one or more processors, causes the one or more processors to further determine a material estimate for each of one or more of roofing shingles, starter strip shingles, roof deck protection underlayment, leak barrier underlayment, or hip/ridge cap shingles based on the digital roof model.

15. The non-transitory computer readable medium of claim 14, wherein the executable code, when executed by the one or more processors, causes the one or more processors to further display each material estimate in the electronic interface.

16. The non-transitory computer readable medium of claim 14, wherein the executable code, when executed by the one or more processors, causes the one or more processors to further:
enable the user to select a waste factor; and
update each material estimate based on the selected waste factor.

17. A computer-implemented method for providing an interactive digital 3D model of a structure, the method comprising:
obtaining a digital roof model corresponding to a roof of the structure;
at least one of:
constructing roof facet edges for the interactive digital 3D model based on the digital roof model, the roof facet edges representing facet edges of the roof; or
constructing roof facet meshes for the interactive digital 3D model based on the digital roof model, the roof facet meshes representing roof facets of the roof;
determining a ground level for the interactive digital 3D model based on the digital roof model, and for each roof facet edge determined to be connected to a single roof facet:
determining a wall vertex list comprising a first vertex of the roof facet edge, a second vertex of the roof facet edge, a third vertex at the ground level corresponding to the first vertex, and a fourth vertex at the ground level corresponding to the second vertex; and
constructing a wall mesh based on the vertex list; and
providing an electronic interface enabling a user to view the interactive digital 3D model, the electronic interface enabling the user to manipulate the interactive digital 3D model, wherein manipulating the interactive digital 3D model comprises at least one of:
enabling the user to select at least one of a roof type or roof texture and view the interactive digital 3D model with the selected at least one of the roof type or roof texture applied to one or more of the roof facet meshes; or
enabling the user to select at least one of a wall type or wall texture and view the interactive digital 3D model with the selected at least one of the wall type or wall texture applied to one or more wall mesh.

18. The computer-implemented method of claim 17, further comprising:
determining a material estimate for each of one or more of roofing shingles, starter strip shingles, roof deck protection underlayment, leak barrier underlayment, or hip/ridge cap shingles based on the digital roof model and a waste factor; and
displaying each material estimate in the electronic interface.

19. The computer-implemented method of claim 17, wherein:
constructing roof facet edges for the interactive digital 3D model comprises, for each roof facet of the roof:
determining the facet edges corresponding to the facet based on vertices for the roof facet in the digital roof model; and
for one or more of the determined roof facet edges:
constructing a digital facet edge element representing the roof facet edge based on two of the vertices of the roof facet, wherein a length of the digital facet edge element corresponds to a distance between the two vertices; and
orienting and positioning the digital facet edge element to match a vector between the two vertices; and
constructing roof facet meshes for the interactive digital 3D model comprises, for each roof facet of the roof:
determining a facet plane for the roof facet based on a normal for the roof facet;
determining snapped vertices in the facet plane corresponding to the vertices for the roof facet in the digital roof model; and
constructing a roof facet mesh for the roof facet based on the snapped vertices in the facet plane.

20. A non-transitory computer readable medium comprising executable code, that when executed by one or more processors, causes the one or more processors to:
obtain a digital roof model corresponding to a roof of a structure;
at least one of:
construct facet edge elements for a digital 3D model of the structure based on the digital roof model, the facet edge elements representing roof facet edges of the roof; or
construct roof facet meshes for the digital 3D model based on the digital roof model, the roof facet meshes representing roof facets of the roof; and
provide an electronic interface enabling a user to view the at least one of the constructed facet edge elements or the constructed roof facet meshes of the digital 3D model, the electronic interface enabling the user to interactively manipulate the digital 3D model to at least one of alter a view of the digital 3D model or alter characteristics of the digital 3D model.
